(19) United States
(12) Patent Application Publication
(10) Pub. No.: US 2009/0064193 A1
(43) Pub. Date: Mar. 5, 2009

(54) Distributed Network Processing System including Selective Event Logging

(75) Inventors: Ryo Chijiiwa, Cerritos, CA (US); Felix Zodak Lee, Portland, OR (US); Brent Douglas Miller, Sunnyvale, CA (US); Albert Song-Ping Wang, Sunnyvale, CA (US)

Correspondence Address: BAKER BOTTS L.L.P., 2001 ROSS AVENUE, 6TH FLOOR, DALLAS, TX, 75201, US

(73) Assignee: Yahoo! Inc., Sunnyvale, CA (US)

(21) Appl. No.: 11/850,249

(22) Filed: Sep. 5, 2007

(51) Int. Cl. G06F 13/14

(52) U.S. Cl. 719/318

(57) ABSTRACT

Systems for selective logging events in a network. In particular implementations, a method includes receiving indications of events associated with a network application; selectively flagging one or more of the events for logging; and applying the events to a processing stream comprising a plurality of process modules. The process modules are operative to receive events from another process module; apply one or more operations in response to the received events; and conditionally transmit one or more log messages identifying flagged events to a log data store.

### TECHNICAL FIELD

The present disclosure generally relates to web-based network applications and, more particularly, to a mechanism for selectively logging events in a distributed network processing system.

### BACKGROUND

Computer systems connected by wide area networks such as the Internet have steadily evolved into vibrant mediums for information exchange. For example, social network sites are fast growing phenomena that provide an interactive medium through which users can create a network of friends for sharing personal information, as well as for exchanging digital media such as music and videos. Social network sites have become an increasingly influential part of contemporary popular culture around the world. A social network site focuses on the building and verifying of online social networks for communities of people who share interests and activities, or who are interested in exploring the interests and activities of others. Most social network services are primarily web based and provide a collection of various ways for users to interact, such as chat, messaging, email, video, voice chat, file sharing, blogging, discussion groups, and the like.

When delivering a web-based or other network application such as a social network website or a dating website, a network application server communicates with other network nodes that perform various processes such as authenticating users, accessing web services, managing payments, storing user account data, etc. During network application development, and/or if there are any problems or failures associated with delivering the web-based application to a given user, a network administrator needs to troubleshoot various physical machines where the processes are performed to determine possible root causes of the problems or failures. Troubleshooting may be time consuming and unreliable, because not all processes have associated failure logs. Many of the processes performed may be performed asynchronously or offline relative to a given user session and are not involved in or relied on for page generation or other synchronous process operations. Accordingly, processing of a given event by these asynchronous processes can be difficult to trace because if a process fails, it often fails in ways that are not apparent or visible to the end-user. For other processes, servers, such as HTTP servers, often maintain a variety of log information; however, the logged information relates typically to all detected events making it difficult to track or correlate how a given client transaction is processed. In addition, the log files, especially, for large network applications having high traffic volumes the log files are not amenable to database storage and are typically maintained in large log files that can be difficult to search and correlate log messages associated with the same event. Still further, for those processes that do have failure logs, the actual logs may expire after a certain amount of time.

### SUMMARY

The present invention provides a method, apparatus, and systems directed to selectively logging events and processing of events in a distributed network processing system. In particular implementations, the present invention provides a network processing system comprising an event selection process that selects events from a plurality of events for logging, and a set of distributed process modules that log messages associated with the selected events. Logging only a subset of all events allows for the logging of detailed information about how events are processed. Furthermore, the resulting reduction in data allows the logged data to be stored in a database, which facilitates correlation of messages via associated database queries, and other analysis and debugging tasks. For a given flagged event, a log flag causes other processes in the chain to log transactions associated with the event and to send a log message to a central data store. In one implementation, an event may be initiated in response to a request associated with a web-based application, and a log message may include an event identifier (ID) for the event and a transaction or transactions associated with the event. In one implementation, the central data store stores an aggregation of log messages, which may be utilized to troubleshoot failures or to monitor the performance of a web-based application.

### DESCRIPTION OF THE DRAWINGS

FIG. 1 illustrates an example network environment in which particular implementations may operate.

FIG. 2 illustrates an example computing system architecture, which may be used to implement a physical server.

FIG. 3 illustrates an example logical relationship among processes in one or more processing paths for processing a given event.

FIG. 4 illustrates an example process flow associated with flagging one or more events.

FIG. 5 illustrates an example process flow associated with logging one or more transactions associated with flagged events.

### DESCRIPTION OF EXAMPLE EMBODIMENTS

### A. Example Network System Architecture

A.1. Example Network Environment

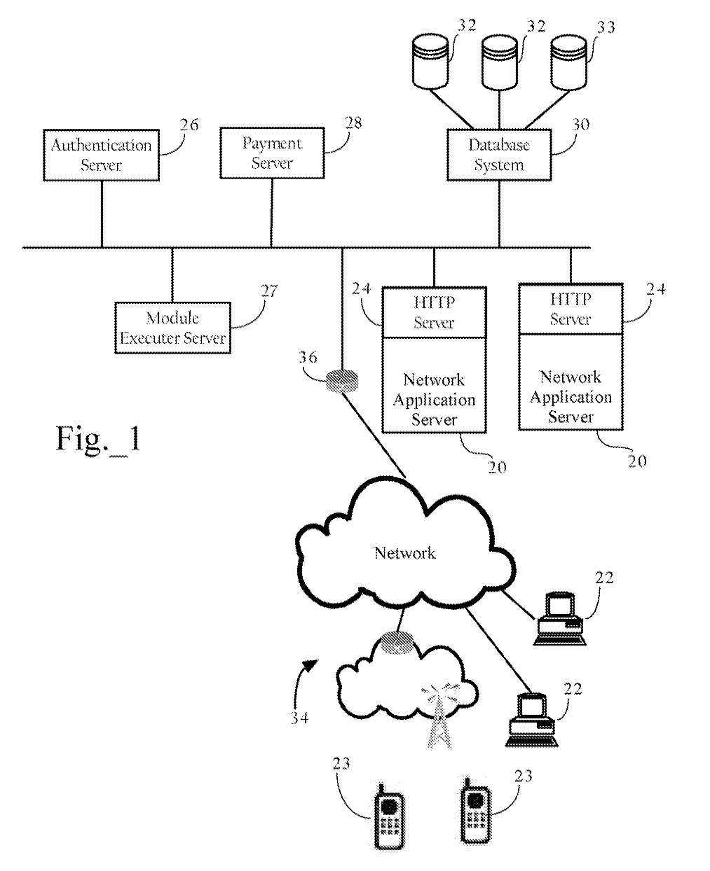

FIG. 1 illustrates an example network environment in which particular implementations may operate. As FIG. 1 illustrates, particular implementations of the invention may operate in a network environment comprising one or more network application servers 20 that are operatively coupled to other functional nodes to deliver a web-based application to one or more end-user clients 22. In particular implementations, examples of web-based applications may include social network websites, dating websites, web-banking sites, electronic commerce sites, etc.

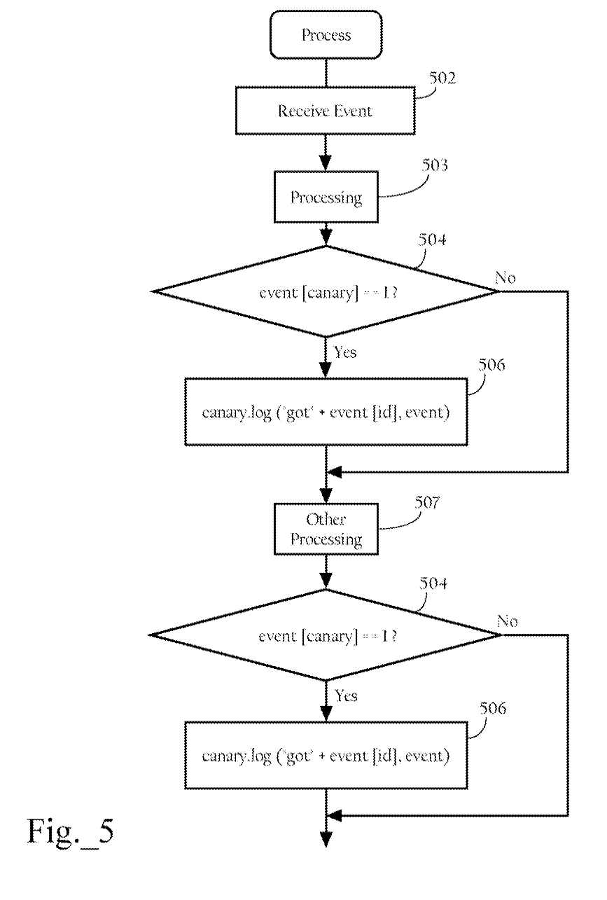

In particular implementations, the functional nodes may perform various processes (e.g., authentication, data retrieval, etc.) and may be hosted on one or more physical servers. For example, such servers may include one or more hypertext transfer protocol (HTTP) servers 24 for interfacing with end-user clients 22, an authentication server 26 for authenticating end-user clients 22, a module executor server 27 for executing various modules for various functions (e.g., access a web service), a payment server 28 for managing payments, a database system 30 operatively coupled to one or more databases 32, and an event log database 33, etc. In one implementation, databases 30 may store various types of information such as user account information, user profile data, addresses, preferences, financial account information, etc. Databases 32 may also store content such as digital content data objects and other media assets. A content data object or a content object, in particular implementations, is an individual item of digital information typically stored or embedded in a data file or record. Content objects may take many forms, including: text (e.g., ASCII, SGML, HTML), images (e.g., jpeg, tif and gif), graphics (vector-based or bitmap), audio, video (e.g., mpeg), or other multimedia, and combinations thereof. Content object data may also include executable code objects (e.g., games executable within a browser window or frame), podcasts, etc. Event log database 33 may store logged events as described below in connection with FIG. 5. Structurally, databases 32 and 33 connote a large class of data storage and management systems. In particular implementations, databases 32 and 33 may be implemented by any suitable physical system including components, such as database servers, mass storage media, media library systems, and the like.

In one implementation, the network application server 20 is operatively coupled to a network cloud 34 via HTTP server 24 and router 36. Network cloud 34 generally represents one or more interconnected networks, over which end-user clients 22 may communicate with the HTTP server 24 to receive the web-based application. Network cloud 34 may include packet-based wide area networks (such as the Internet), private networks, wireless networks, satellite networks, cellular networks, paging networks, and the like. End-user clients 22 are operably connected to the network environment via a network service provider or any other suitable means. End-user clients may include personal computers or cell phones, as well as other types of mobile devices 23 such as lap top computers, personal digital assistants (PDAs), etc.

A.2. Example Server System Architecture

The server host systems described herein may be implemented in a wide array of computing systems and architectures. The following describes example computing architectures for didactic, rather than limiting, purposes.

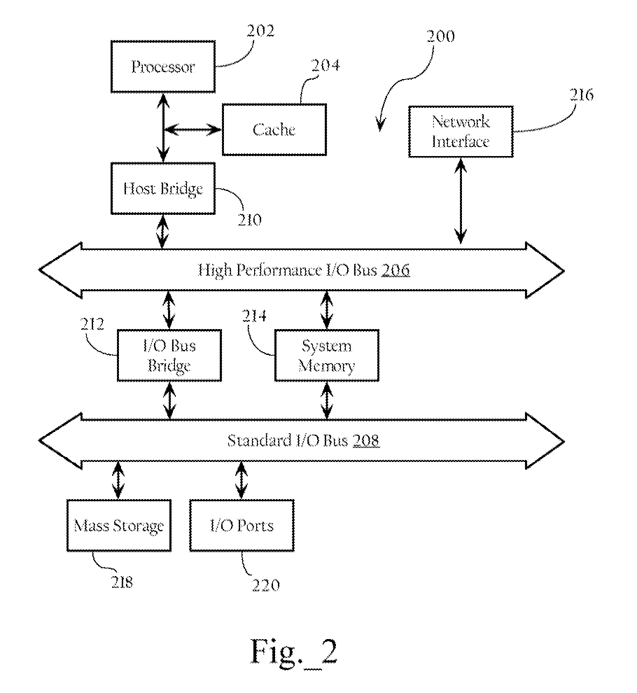

FIG. 2 illustrates an example computing system architecture, which may be used to implement a physical server. In one embodiment, hardware system 200 comprises a processor 202, a cache memory 204, and one or more software applications and drivers directed to the functions described herein. Additionally, hardware system 200 includes a high performance input/output (I/O) bus 206 and a standard I/O bus 208. A host bridge 210 couples processor 202 to high performance I/O bus 206, whereas I/O bus bridge 212 couples the two buses 206 and 208 to each other. A system memory 214 and a network/communication interface 216 couple to bus 206. Hardware system 200 may further include video memory (not shown) and a display device coupled to the video memory. Mass storage 218, and I/O ports 220 couple to bus 208. Hardware system 200 may optionally include a keyboard and pointing device, and a display device (not shown) coupled to bus 208. Collectively, these elements are intended to represent a broad category of computer hardware systems, including but not limited to general purpose computer systems based on the x86-compatible processors manufactured by Intel Corporation of Santa Clara, Calif., and the x86-compatible processors manufactured by Advanced Micro Devices (AMD), Inc., of Sunnyvale, Calif., as well as any other suitable processor.

The elements of hardware system 200 are described in greater detail below. In particular, network interface 216 provides communication between hardware system 200 and any of a wide range of networks, such as an Ethernet (e.g., IEEE 802.3) network, etc. Mass storage 218 provides permanent storage for the data and programming instructions to perform the above described functions implemented in the location server 22, whereas system memory 214 (e.g., DRAM) provides temporary storage for the data and programming instructions when executed by processor 202. I/O ports 220 are one or more serial and/or parallel communication ports that provide communication between additional peripheral devices, which may be coupled to hardware system 200.

Hardware system 200 may include a variety of system architectures; and various components of hardware system 200 may be rearranged. For example, cache 204 may be on-chip with processor 202. Alternatively, cache 204 and processor 202 may be packed together as a “processor module,” with processor 202 being referred to as the “processor core.” Furthermore, certain embodiments of the present invention may not require nor include all of the above components. For example, the peripheral devices shown coupled to standard I/O bus 208 may couple to high performance I/O bus 206. In addition, in some embodiments only a single bus may exist, with the components of hardware system 200 being coupled to the single bus. Furthermore, hardware system 200 may include additional components, such as additional processors, storage devices, or memories.

As discussed below, in one implementation, the operations of one or more of the physical servers described herein are implemented as a series of software routines run by hardware system 200. These software routines comprise a plurality or series of instructions to be executed by a processor in a hardware system, such as processor 202. Initially, the series of instructions may be stored on a storage device, such as mass storage 218. However, the series of instructions can be stored on any suitable storage medium, such as a diskette, CD-ROM, ROM, EEPROM, etc. Furthermore, the series of instructions need not be stored locally, and could be received from a remote storage device, such as a server on a network, via network/communication interface 216. The instructions are copied from the storage device, such as mass storage 218, into memory 214 and then accessed and executed by processor 202.

An operating system manages and controls the operation of hardware system 200, including the input and output of data to and from software applications (not shown). The operating system provides an interface between the software applications being executed on the system and the hardware components of the system. According to one embodiment of the present invention, the operating system is the FreeBSD operating system or variants of this operating system. However, the present invention may be used with other suitable operating systems, such as the Apple Macintosh Operating System, available from Apple Computer Inc. of Cupertino, Calif., UNIX operating systems, LINUX operating systems, Windows® 95/98/NT/XP/Vista operating systems available from Microsoft Corporation of Redmond, Wash., and the like. Of course, other implementations are possible. For example, the server functionalities described herein may be implemented by a plurality of server blades communicating over a backplane.

### B. Processing of an Event by Processes in One or More Processing Paths

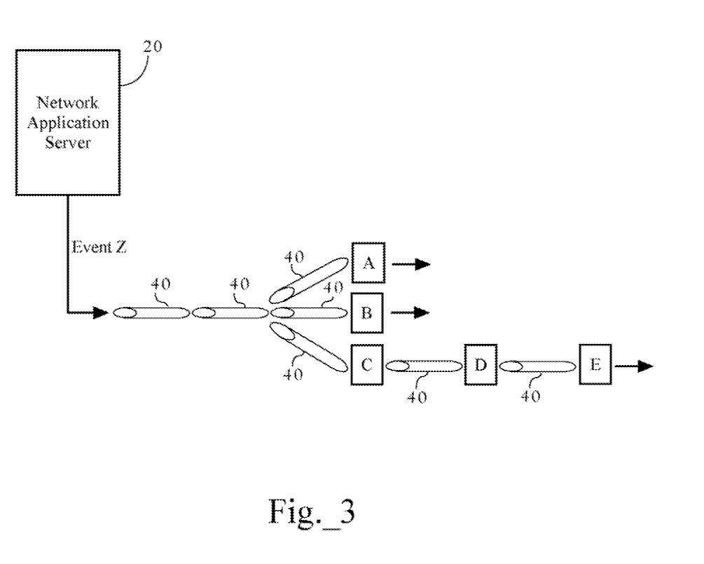

FIG. 3 illustrates an example logical relationship among processes in one or more processing paths for processing a given event. A client request or other attempted access may spawn a number of events processed by a plurality of processing modules, each hosted on the same or different servers, in series, parallel or a combination thereof. An event, for example, may correspond to a user accessing a personal page on a network site, modifying a personal page, viewing a personal page of another user, sending a message to another user. In this example, these actions first appear to network application server 20 as HTTP requests including a uniform resource locator (URL), as well as common gateway interface (GGI) parameters and information in browser cookies appended to the requests. An event may be identified relative to a number of different attributes, such as a user identifiers, IP address, session identifiers, transaction identifiers, time stamps, and combinations of any of the foregoing attributes.

As FIG. 3 illustrates, when a system client, such as client system 22, interacts with the network application server 20, the network application server 20 may generate one or more events to be processed by functional modules in one or more processing paths in order to provide (for example) a web-based application to the end-user client 22. For example, a first page access may involve interactions with a user authentication server, database servers, a presence server, one or more module or customization servers, RSS feeds, web or other network application services, and the like. During a browsing session, a user interaction may include editing a given page, sending messages to other users, changing user account information, etc. If, for example, the interaction involves a request to modify a personal page of a social network site, for example, the network application server 20 may generate an event Z. In particular implementations, an event may be a request that is processed by various process modules A, B, C, D, E, etc. to provide the web-based application to the end-user client 22. These process modules A-E may process event Z in series or in parallel to deliver the web-based application. In one implementation, one or more of the process modules A-E may be off-line processes that are executed asynchronously and are not necessary for page generation. For example, in one implementation, event Z may be “user R modified object O.” Process modules A-E may include functionality that performs operations, such as “update the stats for O,” “replicate the change to multiple data stores,” “queue for review by customer care,” or “send a notification email to a user.”

As discussed above, an event may be initiated upon receipt of an HTTP or other client request. This event may spawn one to many messages in a message processing stream of one or more processes hosted on the same or different servers. One event may split off into multiple processing streams, as FIG. 3 shows. In a particular implementation, data characterizing or related to the event may be maintained in a file or other data structure which is accessed, modified and forwarded between processes. In the implementation shown, the network application server 20 forwards the event Z to process modules A-E via replication streams or tubes 40. In particular implementations, a tube 40 may represent an inter-process communication (IPC) messaging service that functions to send an event such as event Z from one point (e.g., process C) to a next destination (e.g., process D). In particular implementations, an IPC messaging service performs a set of IPC processes for transmitting events. In one implementation, these IPC processes may include operations for message passing, synchronization, shared memory, remote procedure calls (RPC), etc. In a particular implementation, the IPC processing mechanism implements a message queue where a forwarding process can send a message to one or more processes by writing the message onto one or more corresponding messaging queues. The destination process processes messages from the queue.

In one implementation, each of the process modules A-E may be hosted by one or more servers such as those described above in connection with FIGS. 1 and 2. For example, network application server 20 may receive an HTTP request directed to modifying a user account, such as adding a contact to a contact list. The process may spawn an event that is sent to and processed by a number of additional processing nodes, such as a contact management system, a presence server, and the like. Processes implemented on these nodes may receive the event and update one or more data structures to reflect the added contact. Some of the processes may also access additional processes, such as notification mechanisms. For example, a contact management system may implement a process that updates the user's contact list, and accesses a web service, where the web service may provide an email notification to the affected users that the contact update has been updated. In one implementation, events may be injected into the system to simulate partial or complete functionality without actual user interaction. In the event of a network failure or hardware crash, the process may check for configuration mistakes or network connectivity errors. In one implementation, the process may also use “heartbeats” in automated health checks or as part of regression tests.

In particular implementations, each process module A-E may include an application programming interface (API) layer that provides the appropriate APIs for communicating with other functional nodes and with external nodes such as web service publishers. An application programming interface (API) is a source code interface that an application, operating system, or library of a web service publisher provides to support requests made by other programs or processes, such as for web services (e.g., functionality, information, etc.). An API defines specifically how to request particular information. For example, an API may require that a request be sent to a particular destination, that the request include arguments for the information being requested (e.g., time, stock price, etc.), etc. The API may also define the rules, syntax, order of information in the request, etc., that should be included in the request. The API may also define how the request should he sent (e.g., as an HTTP request, by e-mail, etc.).

In a particular implementation, the logging functionality can be implemented as a code library defining a logging API and associated functions. During development of the process modules (e.g., process modules A, B, etc.), the software developer may use the library to embed logging commands at one or more points in the software program code that defines a given process.

### C. Flagging Events

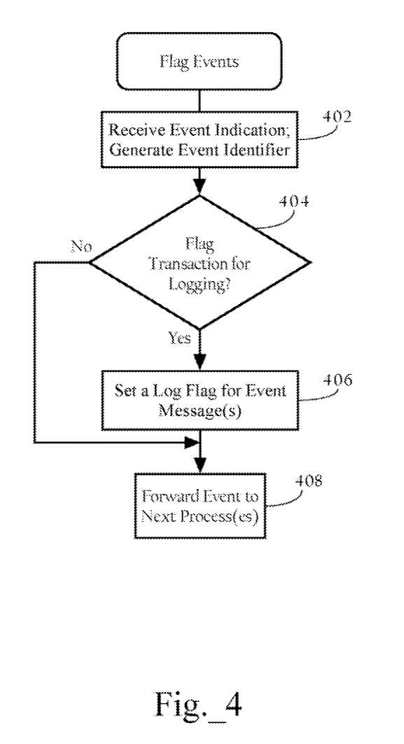

FIG. 4 illustrates an example process flow associated with flagging one or more events. In particular implementations, the first process in the chain of processes initially flags events. For example, HTTP server 24 and/or network application server 20 may, responsive to a new request, make a call to a process that selects which events are flagged. In one implementation the selection may be based on a policy. For example, in one implementation, the selection process may randomly select a small subset of all events. In one implementation, the selection process may select events associated with a particular user or Internet Protocol (IP) address. For example, a network application developer may configure the event selection process to flag events associated with clients having an IP address from a range of IP addresses. In one implementation, the selection process may select events based on time. For example, the selection process may select events that occur at particular time intervals. These clients may be test machines used for debugging purposes. In other implementations, the event selection process may operate on higher level information, such as user account identifiers, and the like. The event selection process may select events that belong to a particular class of events or events associated with users of a particular class or events associated with users of particular classes of users.

While the following process flow is described from the perspective of the network application server 20, the process flow may also be performed by the other processes modules A-E. As FIG. 4 shows, the network application server 20 receives an indication of an event, such as an HTTP request or a message from another process, and generates an event identifier (402). As described above, an event may be a request associated with delivering a web-based application. In one implementation, an event identifier may a tuple of information (e.g., event ID, user identifiers, IP address, time stamps, etc.). The network application server 20 may then make an API call to an event selection process, passing one or more attributes of the event, to determine whether the event should be flagged for logging (404).

If the event selection process indicates that the event should be logged, the network application server 20 sets a log flag or bit (406) in associated event messages that the network application server 20 forwards to one or more additional process modules (408). In particular implementations, a log flag is operative to cause each subsequent process modules A-E in the processing paths to log data associated with each flagged event and to send one or more log messages to an event log database 33. In some implementations, log flags may not be communicated to subsequent process modules via event messages, but may be discovered by subsequent process modules through examination of common resources that associate log flags with particular events. In such an instance, the network application server or another process module could store a log flag along with an identifier or identifiers that are associated with the event.

D. Logging Data Associated with Processed Events

FIG. 5 illustrates an example process flow associated with logging data associated with flagged events. As FIG. 5 shows, when a given process (e.g., process B) down the processing stream receives an event (502), it may perform one or more processing operations (503). As FIG. 5 illustrates, at one or more points in its processing, the receiving process determines if the log flag is set (504). As discussed above, this can be accomplished by accessing a reserved field of the event message, or by accessing a common resource or data store that associates log flags with events. If the log flag is set, the process makes an API call to a logging library to create a log message (506). In particular implementations, the logging library includes code for creating log messages as well as other logging-related functions such as sending log messages to the event log database 33. In one implementation, a log message may include an event identifier, data associated with the flagged event, a process module identifier, etc. In one implementation, the API call (e.g., canary.log) includes transaction information associated with the event (e.g., “got event Z,” event Z ID, etc.) and an event identifier. The logging library, in a particular implementation, defines the APIs and functions for logging events to the event log database 33. The following pseudocode illustrates an example logging API and database write operation that is performed with the canary.log function is called.

```
canary.log (message, event){
    mysql.write(message, event)
    }
```

As FIG. 5 illustrates, the process may perform additional operations (507) and make additional calls to the logging library to log processing of the same event at different stages of operation. Given that a subset of the events are logged, the messages passed to the log can be detailed and provide more information than typical log files. The logged data contained in the messages may include errors, if any, and other information associated with processing the event, such as indicators or codes identifying that the event was received, that the event was processed by a first stage, that the event was forwarded to a subsequent process, and the like.

In particular implementations, the other process modules B-E along the processing paths also log data associated with their respective processing of flagged events and send log messages to the event log database 33. In particular implementations, a given process module A-E may log data at the beginning of its related processes (e.g., “received the event”), anytime during its related processes (e.g., “accessed a web service,” “successfully retrieved information from the web service,” etc.), and/or at the end of its related processes (e.g., “sent the event to functional node B”). In one implementation, each process module may also log transaction times (e.g., time stamps) or other parameters). Accordingly, any failure along the processing paths may be ascertained by analyzing the aggregation of log messages in the event log database 33. For example, in one scenario, it may be determined that all expected process modules A-D performed their expected operations successfully, except for process E. An administrator or automated process may perform appropriate corrective actions.

In one implementation, the log messages stored in the event log database 33 may be sorted in various ways (e.g., by event, by functional node, user ID, requested action, IP address where originated, edit ID from ticket server, etc.). In particular implementations, the sorted log messages may be utilized for debugging problems or for other purposes such as monitoring the overall performance of the system. Because only a small subset of the events are flagged, the overall system needs to process only a small, manageable amount of logging information.

The present invention has been explained with reference to specific embodiments. For example, while embodiments of the present invention have been described as operating in connection IP and HTTP, the present invention can be used in connection with any suitable protocol environment. Other embodiments will be evident to those of ordinary skill in the art. It is therefore not intended that the present invention be limited, except as indicated by the appended claims.

What is claimed is:

1. A method comprising:
receiving indications of events associated with a network application;
selectively flagging one or more of the events for logging, or determining events that are flagged for logging; and
applying the events to a processing stream comprising a plurality of process modules; wherein the process modules are operative to:
receive events from another process module;
apply one or more operations in response to the received events; and
conditionally transmit one or more log messages identifying flagged events to a log data store.

2. The method of claim 1 wherein each log message comprises an event identifier and data associated with processing of the flagged event.

3. The method of claim 1 wherein events are randomly selected for logging.

4. The method of claim 1 wherein events are selected based on time.

5. The method of claim 1 further comprising:
making a call to an event selection process;
transmitting one or more attributes of the event; and
determining whether an event should be flagged for logging based on one or more attributes.

6. The method of claim 1 further comprising applying a policy to select the one or more events.

7. The method of claim 6 wherein the policy is based at least in part on associations with a particular Internet Protocol addresses.

8. The method of claim 6 wherein the policy is based at least in part on particular classes of events.

9. The method of claim 6 wherein the policy is based at least in part on particular classes of users.

10. The method of claim 1 wherein an event is identified relative to a number of different attributes comprising user identifiers, IP address, session identifiers, transaction identifiers, time stamps, and combinations of any of the foregoing attributes.

11. The method of claim 1 wherein the events are logged using logging functionality that is implemented as a code library defining a logging application programming interface and associated functions.

12. A system comprising:
one or more processes implemented on one or more respective host servers; and
logic encoded in one or more tangible media for execution and when executed operable to cause the one or more processes to:
obtain indications of events associated with a network application;
selectively flag one or more of the events for logging; and
apply the events to a processing stream comprising a plurality of process modules; wherein the process modules are operative to:
receive events from another process module;
apply one or more operations in response to the received events; and
conditionally transmit one or more log messages identifying flagged events to a log data store.

13. The system of claim 12 wherein each log message comprises an event identifier and data associated with the flagged event.

14. The system of claim 12 wherein each log message includes a process module identifier.

15. The system of claim 12 wherein events are randomly selected for logging.

16. The system of claim 12 wherein the logic is operable to cause the one or more processes to:
make a call to an event selection process;
transmit one or more attributes of the event; and
determine whether an event should be flagged for logging based on the one or more attributes.

17. The system of claim 12 further comprising applying a policy to select the one or more events.

18. The system of claim 17 wherein the policy is based at least in part on associations with a particular Internet Protocol addresses.

19. The system of claim 17 wherein the policy is based at least in part on particular classes of events.

20. The system of claim 17 wherein the policy is based at least in part on particular users or particular classes of users.

21. The system of claim 12 wherein an event is identified relative to a set of attributes from a plurality of attributes comprising user identifiers, Internet Protocol address, session identifiers, transaction identifiers, time stamps, and combinations of any of the foregoing attributes.

22. The system of claim 12 wherein the events are logged using logging functionality that is implemented as a code library defining a logging application programming interface and associated functions.
